(19) United States
(12) Patent Application Publication
(10) Pub. No.: US 2015/0075837 A1
(43) Pub. Date: Mar. 19, 2015

(54) COMPRESSION FORMED CONNECTOR FOR CARBON-FIBER COMPOSITE CORE CONDUCTOR ASSEMBLY USED IN TRANSMISSION LINE INSTALLATIONS AND METHOD OF CONSTRUCTING THE SAME

(71) Applicant: AFL Telecommunications LLC, Duncan, SC (US)

(72) Inventors: Matthew G. Welborn, Greenville, SC (US); Wayne Quesnel, Moore, SC (US)

(73) Assignee: AFL TELECOMMUNICATIONS LLC, Duncan, SC (US)

(21) Appl. No.: 14/389,586

(22) PCT Filed: Feb. 20, 2014
(86) PCT No.: PCT/US2014/017266

§ 371 Date: Sep. 30, 2014

Related U.S. Application Data
(60) Provisional application No. 61/767,037, filed on Feb. 20, 2013.

(51) Int. Cl. H01R 4/20; H01R 43/20

(52) U.S. Cl. CPC H01R 4/20; H01R 43/20
USPC 174/90; 29/882

(57) ABSTRACT

A compression accessory including an insert sleeve configured to enclose at least part of a core strand of a transmission conductor, the insert sleeve having at least one slot on an outer wall of the insert sleeve and a bored sleeve configured to enclose at least part of the insert sleeve, an inner wall of the bored sleeve configured to interact with the at least one slot.

### CROSS-REFERENCE TO RELATED APPLICATION

This application is based upon and claims the benefit of priority from U.S. Provisional Application No. 61/767,037, filed Feb. 20, 2013, in the United States Patent and Trademark Office, the disclosures of which are incorporated herein in its entirety by reference.

### BACKGROUND

1. Field

The invention is related to a compression formed connector, and more particularly to a compression formed connector for use in transmission line installations.

2. Related Art

Conventional overhead conductor core material can be held together using conventional power conductor compression accessories without worrying if the conductor core would be damaged. Unfortunately, the newly developed carbon fiber composite core overhead conductor has a core material that is more fragile than the conventional core material and would be damaged by conventional power conductor compression accessories.

Therefore, there is a need for a compression accessory to attach the new carbon fiber composite core overhead conductor. There exists two-die compression accessory technology that is currently used to attach conventional overhead conductors. However, no existing two-die compression accessory technology offers a means of attaching compression accessories to the new carbon fiber composite core conductor. The existing two-die compression accessory technology causes damage to the composite core and does not achieve the desired holding strength required to put the accessory into field use.

Therefore, there is a need for a compression accessory that will achieve the industry-standard holding strength, while not causing damage to the newly developed carbon fiber composite core of the overhead conductor.

### SUMMARY

Exemplary implementations of the present invention address at least the above problems and/or disadvantages and other disadvantages not described above. Also, the present invention is not required to overcome the disadvantages described above, and an exemplary implementation of the present invention may not overcome any of the problems listed above.

According to an exemplary embodiment, there is provided a compression accessory, including an insert sleeve configured to enclose at least part of a core strand of a transmission conductor, the insert sleeve having at least one slot on an outer wall of the insert sleeve and a bored sleeve configured to enclose at least part of the insert sleeve, an inner wall of the bored sleeve configured to interact with the at least one slot.

In another exemplary embodiment, there is provided a substance that may coat at least part of an inner wall of the insert sleeve, and the substance may aid in gripping the core strand.

In one exemplary embodiment, the substance may include a silicon carbide grit.

In yet another exemplary embodiment, the bored sleeve may be a bored forging.

In one exemplary embodiment, the at least one slot may be formed axially with respect to a through hole of the insert sleeve.

According to an exemplary embodiment, the insert sleeve may be configured to be compressed against the core strand.

In another exemplary embodiment, the insert sleeve may splice together a plurality of core strands.

In one exemplary embodiment, the compression accessory may include a tubular body which may be configured to enclose at least part of an outer strand of the transmission conductor and at least part of the bored sleeve.

In yet another exemplary embodiment, the compression accessory may be configured to maintain a holding strength of at least 95%.

According to another exemplary embodiment, an outer wall of the bored sleeve may include at least one projection.

According to an exemplary embodiment, there is provided a compression accessory, including an insert sleeve having a substance coating at least part of an inner wall of the insert sleeve, where the substance aids in gripping the core strand, and a bored sleeve which is configured to enclose at least part of the insert sleeve.

In one exemplary embodiment, an outer wall of the insert sleeve may include at least one slot.

According to another exemplary embodiment, the at least one slot may be formed axially with respect to a through hole of the insert sleeve.

In yet another exemplary embodiment, the bored sleeve may be a bored forging.

According to an exemplary embodiment, the insert sleeve may be configured to be compressed against the core strand.

In another exemplary embodiment, the insert sleeve may splice together a plurality of core strands.

According to another exemplary embodiment, the compression accessory includes a tubular body which may be configured to enclose at least part of an outer strand of the transmission conductor and at least part of the bored sleeve.

In yet another exemplary embodiment, the compression accessory may be configured to maintain a holding strength of at least 95%.

According to an exemplary embodiment, there is provided a method of attaching a compression accessory to a transmission conductor, the method including placing an insert sleeve around at least part of a core strand of a transmission conductor, compressing the insert to the core strand, placing a bored sleeve around at least part of the insert sleeve, compressing the bored sleeve to the insert sleeve, wherein at least one slot on an outer wall of the insert sleeve interacts with an inner wall of the bored sleeve, placing a tubular body around at least part of the bored sleeve and at least part of an outer strand of the transmission conductor; and compressing the outer tubular body to the insert sleeve and the outer strand.

### BRIEF DESCRIPTION OF THE DRAWINGS

The above and other objects, features, and advantages of the present invention will become more readily apparent from the following detailed description of exemplary embodiments of the invention, taken in conjunction with the accompanying drawings, in which:

FIG. 1 is a cutaway view of a deadend compression accessory;

FIGS. 2A-2B are cutaway views of an insert sleeve and a tubular body of a splice compression accessory;

FIG. 3A is a front view of an opening of an insert sleeve of a compression accessory;

FIG. 3B is a side view of an insert sleeve of a compression accessory;

FIG. 4 is a side view of a deadend compression accessory attached to a terminal;

FIG. 5 is a cutaway view taken along the line 5-5 of FIGS. 1, 2A, and 2B and illustrates a cross-sectional view of an end portion of either tubular body of a compression accessory compressed around outer strands of a transmission conductor;

FIG. 6 is a cutaway view taken along the line 6-6 of FIGS. 1, 2A, and 2B and illustrates a cross-sectional view of a core load transferring section of a compression accessory;

FIG. 7 is a cutaway view taken along the line 7-7 of FIG. 1 and illustrates a cross-sectional view of the tubular body compressed around a bored forging of a deadend compression accessory;

FIG. 8 is a cutaway view taken along the line 8-8 of FIG. 1 and illustrates a cross-sectional view of the tubular body compressed around a corrugation of the bored forging of a deadend compression accessory;

FIG. 9 is a cutaway view taken along the line 9-9 of FIG. 1 and illustrates a cross-sectional view of the uncompressed tubular body enclosing the bored forging of a deadend compression accessory; and

FIG. 10 is a cutaway view taken along the line 10-10 of FIGS. 1, 2A, and 2B and illustrates the manner in which the bored forging and insert sleeve of the compression accessory are compressed onto the core strand of a transmission conductor.

### DETAILED DESCRIPTION

The following detailed description is provided to gain a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

In the following description, like drawing reference numerals are used for like elements, even in different drawings. The matters defined in the description, such as detailed construction and elements, are provided to assist in a comprehensive understanding of exemplary embodiments. However, exemplary embodiments can be practiced without those specifically defined matters, and the inventive concept may be embodied in many different forms and should not be construed as being limited to the exemplary embodiments set forth herein. Also, well-known functions or constructions are not described in detail when it is deemed they would obscure the application with unnecessary detail.

It will be understood that, although the terms used in the present specification may be used herein to describe various elements, these elements should not be limited by these terms. These terms are only used to distinguish one element from another.

Hereinafter, the term “splice compression accessory” refers to a device for joining two or more transmission conductors. This term may be used interchangeably with the term “joint compression accessory” or any other term known in the art that is used to join two or more elements such as, but not limited to, transmission conductors.

Hereinafter, an exemplary embodiment will be described with reference to the accompanying drawings.

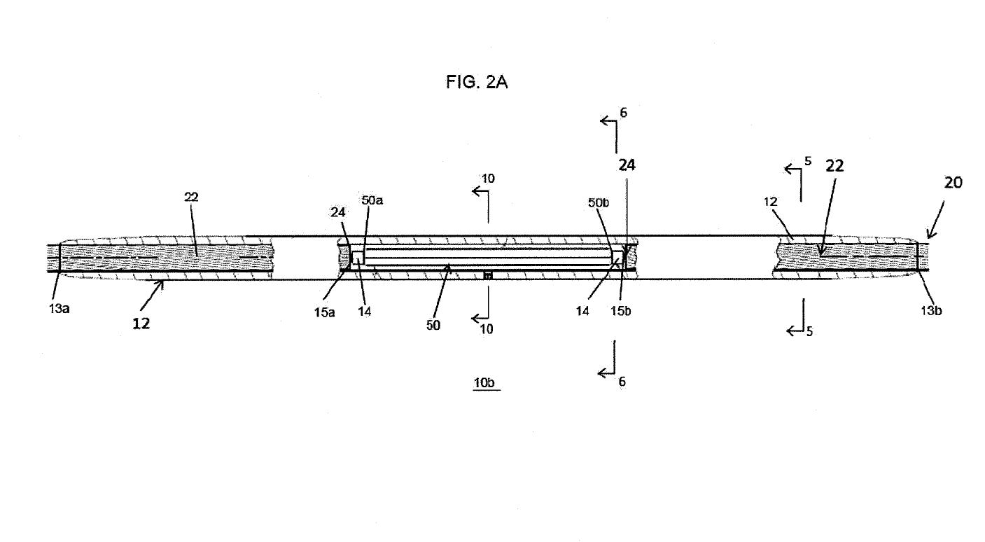

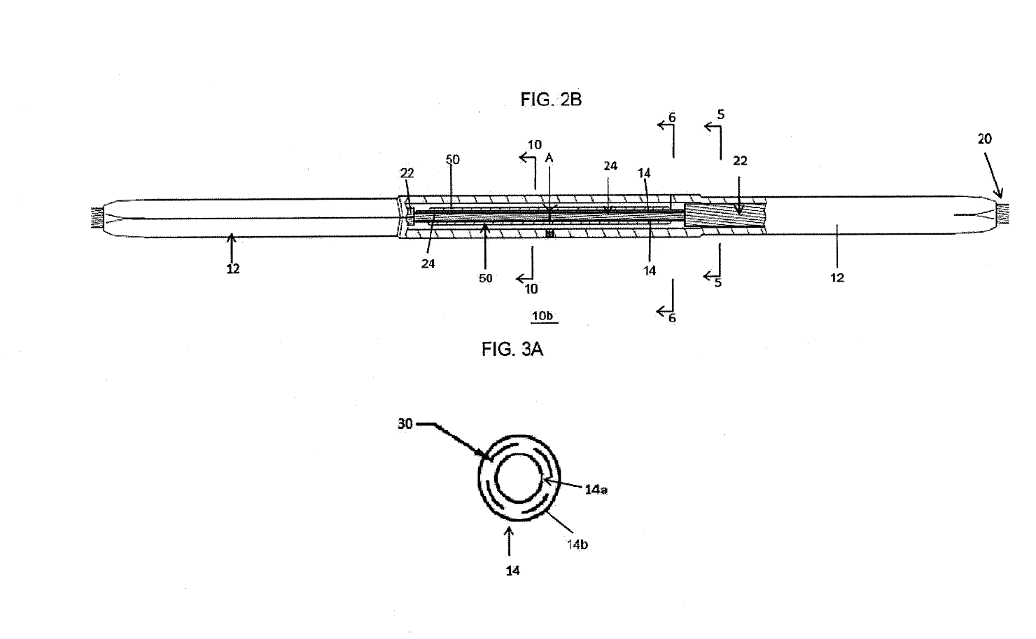

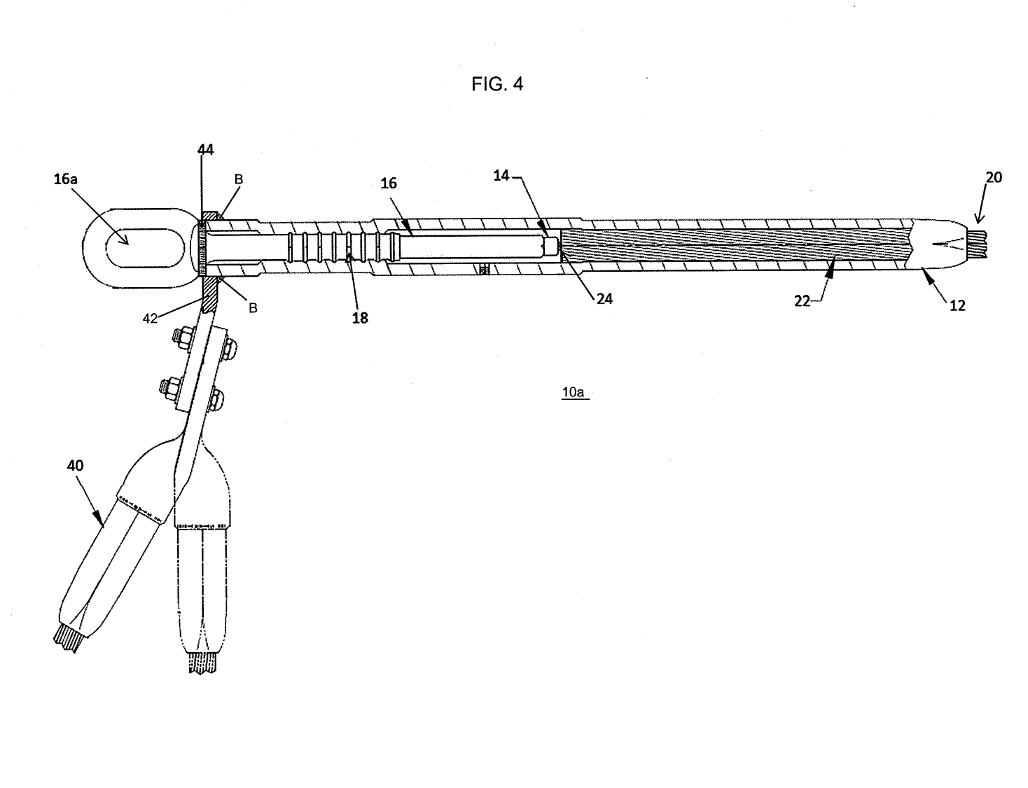

Referring to the drawings, FIG. 4 shows an exemplary embodiment of a deadend compression accessory 10a, while FIG. 2 shows an exemplary embodiment of a splice compression accessory 10b. The deadend compression accessory 10a and the splice compression accessory 10b are two exemplary embodiments of a compression accessory 10. Any reference made herein to the compression accessory 10 includes, but is not limited to, the deadend compression accessory 10a and the splice compression accessory 10b.

Referring to the drawings, FIG. 4 shows an exemplary embodiment of the deadend compression accessory 10a connected to a terminal 40 via a terminal pad 42, according to an exemplary embodiment.

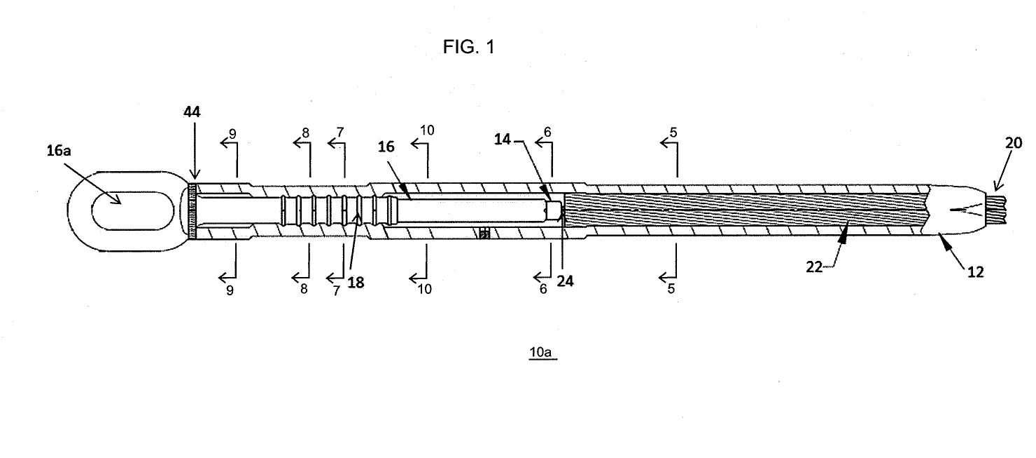

As shown in FIG. 1, there is a cutaway view of the deadend compression accessory 10a according to an exemplary embodiment. In this exemplary embodiment, the deadend compression accessory 10a includes a bored forging 16, an insert sleeve 14, and a tubular body 12. The insert sleeve 14 has a first end 15a and a second end 15b, as shown in FIG. 2A. In one exemplary embodiment, the insert sleeve 14 is a hollow sleeve having a polygonal (hexagonal, circular, etc.) cross-sectional shape. In one exemplary embodiment, it is preferred that the insert sleeve 14 be constructed from a suitable conductive material, such as aluminum. However, it will be understood that the insert sleeve 14 can be constructed from any material having the necessary rates of ductility and extrusion to connect carbon fiber composite core overhead conductors. Furthermore, it will be understood that the insert sleeve can be any shape, depending on the characteristics of the strand 24, the shape of a compression die (not shown), or the desired use of the compression accessory 10.

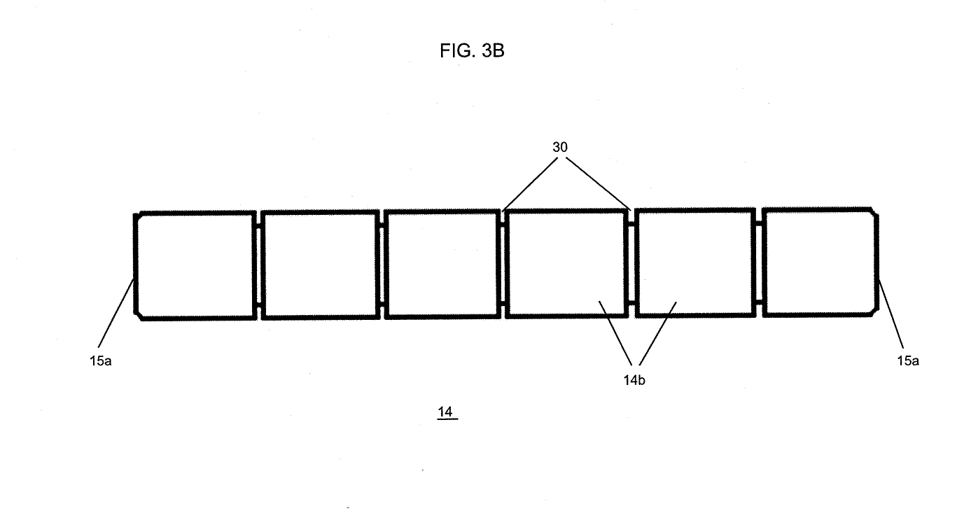

The insert sleeve 14 has an interior wall 14a, as illustrated in FIG. 3A. In one exemplary embodiment, the insert sleeve 14 has a diameter slightly greater than the diameter of a core strand 24 of a transmission conductor 20. Thus, the insert sleeve 14 can fit snugly around the core strand 24.

It will be understood that the diameter of the interior wall 14a is not limited, and may vary depending on the characteristics of the core strand 24, the shape of a compression die (not shown), or the desired use of the compression accessory 10. In addition, the insert sleeve 14 includes one or more slots 30 on an outer wall 14b, as shown in FIGS. 3A and 3B. According to one exemplary embodiment, the inner wall 14a is lined with a silicon carbide grit (not shown) to prevent the insert sleeve 14 from sliding along core strand 24 and to prevent the core strand 24 from snapping. It will be understood that a silicon carbide grit is but one exemplary embodiment of the invention, and any substance known in the art, which is suitable to increase the gripping strength of the insert sleeve 14 according to the necessary specifications, may be used to coat the inner wall 14a.

The slots 30 on the outer wall 14b and the silicon carbide grit that lines an inner wall 14a of insert sleeve 14 provides additional holding strength to grip a transmission conductor 20. This assists the deadend compression accessory 10a or the splice compression accessory 10b to maintain a proper holding strength of the conductor system without compromising the integrity of a conductor system, while allowing the transmission conductor 20 to carry the electrical current through either compression accessory 10. The conductor system includes, but is not limited to, the transmission conductor 20 and the compression accessory 10.

In one exemplary embodiment, the compression accessory 10 assists in providing a conductor system rated holding strength of at least 95%. However, it will be understood that the compression accessory 10 can assist in maintaining different holding strengths depending on the characteristics of the conductor system and the desired use of the compression accessory 10.

In one exemplary embodiment, insert sleeve 14 includes five slots 30 on the outer wall 14b. However, it will be understood that insert sleeve 14 can be constructed with any number of slots 30 in order to provide the proper holding strength, according to the characteristics of the strand 24 or the conductor system, the shape of a compression die (not shown), or the desired use of the compression accessory 10. Furthermore, in one exemplary embodiment, the slots 30 are configured axially with respect to a center of a through hole (not shown) of the insert sleeve 14, the through hole having the inner wall 14a. 14. However, the slots 30 may be configured in any direction, including being transverse with respect to a center of the through hole of the insert sleeve 14.

Referring to FIG. 1, according to an exemplary embodiment, there exists a steel-formed bored forging 16. The bored forging 16 includes corrugations 18 and an eye-hole 16a at a first end of the bored forging 16. In an exemplary embodiment, the bored forging 16 has a polygonal (hexagonal, circular, etc.) cross sectional shape. However, it will be understood that the bored forging 16 can be any shape, determined by the shape of the insert sleeve 14 or the tubular body 12, or determined by the desired use of the compression accessory 10. In addition, the bored forging 16 has an inner diameter slightly larger than the outer diameter of the insert sleeve 14. Thus, the bored forging 16 can fit snugly around the insert sleeve 14. It will be understood that the inner diameter of the bored forging 16 is not limited, and may vary depending on the characteristics of the insert sleeve 14, the shape of a compression die (not shown), or the desired use of the compression accessory 10.

While the bored forging 16 is constructed from a suitable steel material, it will be understood that the bored forging 16 can be constructed from any material having the necessary rates of ductility and extrusion to connect carbon fiber composite core overhead conductors. Furthermore, the eye-hole 16a is but one shape and size of the first end of the bored forging 16. It will be understood that the eye-hole 16a can be any size or shape depending on the characteristics of the connector system.

An aluminum tubular body 12 is provided, having a first end 13a and a second end 13b. In an exemplary embodiment, the tubular body 12 has a polygonal (hexagonal, circular, etc.) cross sectional shape, as illustrated by FIGS. 2A and 2B. However, it will be understood that tubular body 12 can be any shape, depending on the characteristics of the strand 24, the shape of a compression die (not shown), or the desired use of the compression accessory 10.

In one exemplary embodiment, the tubular body 12 has an inner diameter slightly larger than the outer diameter of an outer strand 22 of the transmission conductor 20, so the tubular body 12 can fit snugly around the outer strand 22. It will be understood that the inner diameter of the tubular body is not limited, and may vary depending on the characteristics of the transmission conductor 20, bored forging 16, the bored sleeve 50, the shape of a compression die (not shown), or the desired use of the compression accessory 10.

Although tubular body 12 is constructed from a suitable aluminum material in one preferred embodiment, it will again be understood that the tubular body 12 can be constructed from any material having the necessary rates of ductility and extrusion to connect carbon fiber composite core overhead conductors and to allow the transmission conductor 20 to carry the electrical current through the compression accessory 10.

In one exemplary embodiment, the transmission conductor 20 is provided, having a core strand 24 and an outer strand 22. The core strand 24 and the outer strand 22 are each constructed with at least one or more strands, which are suitable to conduct high current transfer (power) across long distances.

In a preferred embodiment, the outer strand 22 is constructed to include twenty-six (26) strands constructed of aluminum. However, it will be understood that the outer strand 22 may be constructed from any number of strands, the strands being constructed using any material suitable to conduct high current transfer (power).

In addition, in an exemplary embodiment, the core strand 24 of the transmission conductor 20 is provided with seven (7) strands, each strand being constructed of a carbon fiber polymer mix. However, it will be further understood that core strand 22 may be constructed from any number of strands, and the strands may be constructed using any material suitable to conduct high current transfer (power).

Referring now to FIGS. 2A and 2B, there exists another preferred embodiment of the compression accessory 10, including the splice compression accessory 10b. The splice compression accessory 10b includes the insert sleeve 14, with inner wall 14a covered in a grit-like substance and the outer wall 14b having slots 30. In addition, the splice compression accessory 10b includes a bored sleeve 50 to cover the insert sleeve 14, and the tubular body 12 to cover the bored sleeve 50 and the outer strand 22 of the transmission conductor. The bored sleeve 50 includes a first end 50a and a second end 50b, as shown in FIGS. 2A and 2B. Furthermore, while it is preferred that the bored sleeve 50 is composed of steel, it will be understood that bored sleeve 50 may be composed of any material known in the art having the necessary rates of ductility and extrusion to connect carbon fiber composite core overhead conductors.

The interaction of the above-identified features will now be explained, according to one or more exemplary embodiments.

As shown in FIG. 2A, in both the deadend compression accessory 10a and the splice compression accessory 10b, the insert sleeve 14 is placed around the core strand 24 so that the diameter of the inner wall 14a of the insert sleeve 14 encloses at least part of the core strand 24. The inner wall 14a is covered with the grit, increasing the holding strength of the compression accessory 10 on the transmission conductor 20. The grit, along with the slots 30 on outer wall 14b, assist in maintaining the required holding strength for the conductor system. As seen in FIGS. 2A and 2B, the insert sleeve 14 does not extend along the entire length of the core strand 24. However, if necessary, the insert sleeve can extend along the entire length of the core strand 24.

According to an exemplary embodiment, the bored forging 16 of the deadend compression accessory 10a is placed around the insert sleeve 14. The bored forging 16 encloses at least part of the insert sleeve 14. As shown in FIG. 1, the bored forging 16 does not extend along the entire length of the insert sleeve 14. However, depending on the specification and requirements of the holding strength of the compression accessory 10, the bored forging may extend along the entire length of the insert sleeve 14.

The tubular body 12 is positioned so as to enclose at least part of the outer strand 22 and the bored forging 16, according to an exemplary embodiment of the deadend compression accessory 10a, as illustrated in FIG. 1. In one exemplary embodiment, the tubular body 12 is able to interact with the corrugations 18 on the bored forging 16 in order to increase a gripping strength of the compression accessory 10a on the transmission conductor 20. It will be understood that corrugations 18 may include any type of projection or projections, such as, but not limited to, a screw thread.

In another exemplary embodiment, the bored sleeve 50 includes corrugations 30 on an outer wall. As with the bored forging 16, the corrugations 30 are not limited thereto, and the bored sleeve 50 may include any type of projection of projections.

According to an exemplary embodiment, the deadend compression accessory 10b is attached to a terminal 40 by the bored forging 16, the terminal pad 42, and the tubular body 12 as shown in FIG. 4. The bored forging 16 has a washer 44 toward the end of the bored forging 16 having eye hole 16a. The bored forging 16 is placed into the tubular body 12 so that at least part of the bored forging 16 is enclosed by tubular body 12. The deadend compression accessory 10a is attached to the terminal 40 by the tubular body 12, which is welded to the terminal pad 42 at B, as shown in FIG. 4. It will be understood that the deadend compression accessory 10a can be attached to the terminal 40 by any method known in the art.

The eye hole 16a of bored forging 16 is positioned on a first side of the terminal pad 42, the washer 44 being placed between the eye hole 16a and the terminal pad 42. The tubular body 12 is then placed so as to enclose as least part of bored forging 16, as discussed in further detail above. In one exemplary embodiment, the washer 44 is constructed of felt. However, the washer may be constructed of any material known in the art to insulate the terminal 40 and terminal pad 42 from the compression accessory 10.

In another exemplary embodiment, the sleeve 14 in the splice compression accessory 10b is positioned so as to enclose at least part of two or more core strands 24, as shown in FIG. 2B. This allows the splice compression accessory 10b to splice, or join together, the two or more core strands 24. As shown in FIG. 2B, the two or more core strands 24 will be spliced together and an end of each of the two or more core strands 24 will abut each other at A. In addition, the bored sleeve 50 of the splice compression accessory 10b encloses at least part of the insert sleeve 14, as shown in FIG. 2B. As with the bored forging 16, the bored sleeve 50 may or may not extend along the entire length of the insert sleeve 14.

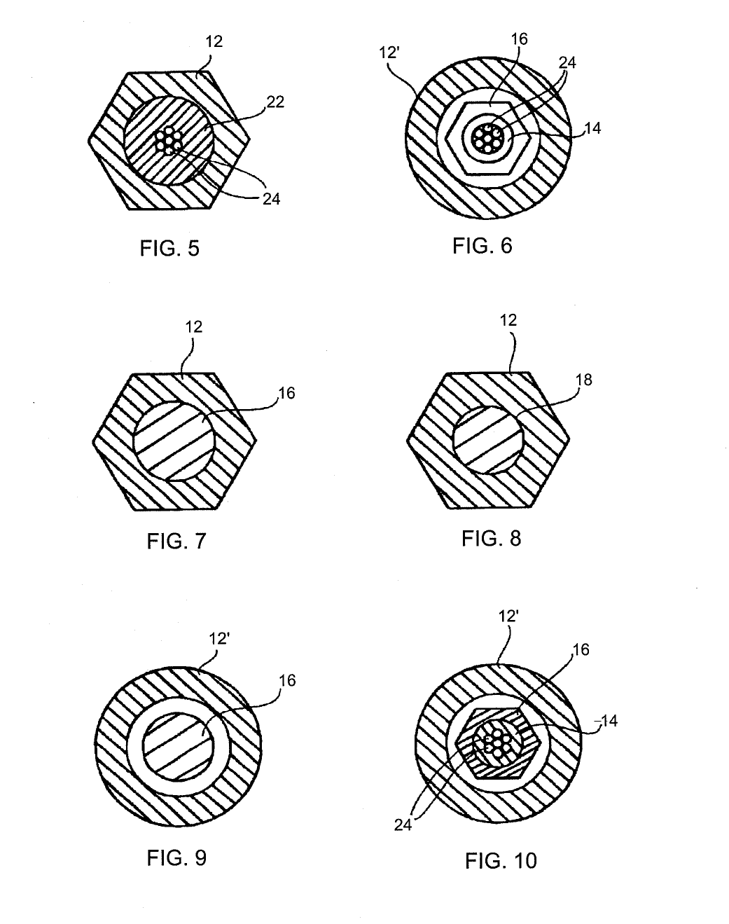

As seen in FIGS. 5-10, there is shown cross-sectional views of exemplary embodiments of a compression accessory 10. While each of FIGS. 5-10 show cross-sectional views of exemplary embodiments of the deadend compression accessory 10a, it will be understood that these cross-sectional views are illustrative of exemplary embodiment of the splice compression accessory 10b.

Referring now to FIG. 5, there is shown a cross-sectional view of the tubular body 12 of a compression accessory 10 enclosing and compressing the outer strand 22 of a transmission conductor 20. In addition, the core strand 24 can be seen being enclosed by the outer strand 22. While the compressed tubular body 12 is shown as a hexagon, it will be understood that the compression may form any other polygonal or circular shape.

As seen in FIG. 6, there is illustrated a cross-sectional view of an uncompressed tubular body 12′ enclosing a bored forging 16 of the deadend compression accessory 10a. The bored forging 16 is enclosing and compressed around the insert sleeve 14, which in turn encloses and is compressed to the core strand 24 of the transmission conductor 20. It will be understood that the bored forging 16 is illustrative of a compression of the bored sleeve 50 of the splice compression accessory 10b around the insert sleeve 14.

FIG. 7 shows a cross-sectional view of the tubular body 12 compressed to the bored forging 16. It will be understood that bored forging 16 of FIG. 7 is illustrative of a compression of the tubular body 12 to the bored sleeve 50 of the splice compression accessory 10b. In addition, FIG. 8 shows a cross-sectional view of the tubular body 12 compressed to the corrugation 18 of the bored forging 16.

As illustrated in FIGS. 9 and 10, there is shown a cross-sectional view of the uncompressed tubular body 12′ enclosing the bored forging 16, where the bored forging is enclosing and compressed to the insert sleeve 14, which in turn is enclosing and compressed to the core strand 24. It will be understood that the bored forging 16 of FIGS. 9 and 10 is illustrative of the bored sleeve 50 of the splice compression accessory 10b.

Next, a method of assembling the above-identified features will be provided, according to an exemplary embodiment.

In one exemplary embodiment, a steel hexagonal die (not shown) is used to compress the steel bored forging 16 or, alternatively, the bored sleeve 50, and the aluminum insert sleeve 14 onto core strand 24. However, the die is not limited to a steel hexagonal die, and may be constructed of any material and be any shape known to one of ordinary skill in the art, depending on the material and shape of the bored forging 16, the bored sleeve 50, or the insert sleeve 14.

During the compression of the bored forging 16 and the insert sleeve 14 or the compression of the bored sleeve 50 and the insert sleeve 14, the insert sleeve 14 is compressed so that the slots 30 are compressed against the inner wall (not shown) of the bored forging 16 or an inner wall (not shown) of the bored sleeve 50, and the grit on the inner wall 14a of the insert sleeve 14 is compressed against the core strand 24. The combination of the slots 30 and the grit assist in providing a suitable holding strength over the conductor system and allows the transmission conductor 20 to carry the electrical current through the compression accessory 10.

According to another exemplary embodiment, after the bored forging 16 and the insert sleeve 14 are compressed around the core strand 24, the tubular body 12 is placed over bored forging 16, so as to enclose at least part of bored forging 16, and the transmission conductor 20, so as to enclose at least part of outer strand 22. An aluminum hexagonal die (not shown) is used to compress the tubular body 12 over the outer strand 22. The placement of tubular body 12 is such that tubular body 12 is compressed over at least part of the outer strand 22 and at least part of the bored forging 16.

During the compression of the tubular body 12, the tubular body 12 and the corrugations 18 are compressed, increasing the holding strength between the tubular body 12 and the bored forging 16. In addition, the tubular body 12 is compressed around the outer strand 22, further assisting in providing the proper holding strength between the compression accessory 10 and the transmission conductor 20, to provide the required holding strength over the entire conductor system.

In yet another exemplary embodiment, the tubular body 12 encloses at least part of the bored sleeve 50 and the outer strand 22 of the transmission conductor 20, as shown in FIG. 2B. An aluminum hexagonal die (not shown) is used to compress the tubular body 12 over the outer strand 22. The placement of tubular body 12 is such that tubular body 12 is compressed over at least part of the outer strand 22 and at least part of the bored sleeve 50. This compression assists the compression accessory to maintain the required holding strength of the conductor system.

It will be understood that the die is not limited to an aluminum hexagonal die, and may be constructed of any material and be any shape known to one of ordinary skill in the art, depending on the material and shape of the bored forging 16, the bored sleeve 50, or the outer strand 22.

It will also be understood that the compression of both the bored forging 16 or the bored sleeve 50 around the insert sleeve 14 and the core strand 24, and the compression of the tubular body 12 around the bored forging 16 around the bored sleeve 50 and the outer strand 22 may be accomplished using any other method known in the art, and is not limited to compression dies.

As discussed above, although the exemplary embodiments described above is a compression accessory for a core conductor, they are merely exemplary and the general inventive concept should not be limited thereto, and it could also apply to other types of compression accessories and other types of cables. Furthermore, while exemplary embodiments described above indicated shapes and/or materials of a compression accessory for a core conductor, any shape and/or materials of the compression or the core conductor known to one skilled in the art may be used, depending on the user's preference as well as the requirements of the specific situation.

What is claimed:

1. A compression accessory, comprising:
an insert sleeve configured to enclose at least part of a core strand of a transmission conductor, the insert sleeve having at least one slot on an outer wall of the insert sleeve; and
a bored sleeve configured to enclose at least part of the insert sleeve,
wherein an inner wall of the bored sleeve is configured to interact with the at least one slot.

2. The compression accessory of claim 1, further comprising:
a substance coating at least part of an inner wall of the insert sleeve, wherein the substance aids in gripping the core strand.

3. The compression accessory of claim 2, wherein the substance comprises a silicon carbide grit.

4. The compression accessory of claim 1, further comprising a tubular body configured to enclose at least part of an outer strand of the transmission conductor and at least part of the bored sleeve.

5. The compression accessory of claim 4, wherein the compression accessory is configured to maintain a holding strength of at least 95%.

6. The compression accessory of claim 1, wherein the bored sleeve is configured as a bored forging.

7. The compression accessory of claim 1, wherein the at least one slot is formed axially with respect to a through hole of the insert sleeve.

8. The compression accessory of claim 1, wherein the insert sleeve is configured to be compressed against the core strand.

9. The compression accessory of claim 1, wherein the insert sleeve is configured to splice together a plurality of core strands.

10. The compression accessory of claim 1, wherein an outer wall of the bored sleeve includes at least one projection.

11. A compression accessory, comprising:
an insert sleeve configured to enclose at least part of a core strand of a transmission conductor, the insert sleeve having a substance coating at least part of an inner wall of the insert sleeve, wherein the substance aids in gripping the core strand; and
a bored sleeve configured to enclose at least part of the insert sleeve.

12. The compression accessory of claim 11, further comprising at least one slot on an outer wall of the insert sleeve.

13. The compression accessory of claim 12, wherein the at least one slot is formed axially with respect to a through hole of the insert sleeve.

14. The compression accessory of claim 11, further comprising a tubular body configured to enclose at least part of an outer strand of the transmission conductor and at least part of the bored sleeve.

15. The compression accessory of claim 14, wherein the compression accessory is configured to maintain a holding strength of at least 95%.

16. The compression accessory of claim 11, wherein the bored sleeve is configured as a bored forging.

17. The compression accessory of claim 11, wherein the insert sleeve is configured to be compressed against the core strand.

18. The compression accessory of claim 11, wherein the insert sleeve is configured to splice together a plurality of core strands.

19. The compression accessory of claim 11, wherein an outer wall of the bored sleeve includes at least one projection.

20. A method of attaching a compression accessory to a transmission conductor, the method comprising:
placing an insert sleeve around at least part of a core strand of a transmission conductor;
compressing the insert to at least part of the core strand;
placing a bored sleeve around at least part of the insert sleeve;
compressing the bored sleeve to at least part of the insert sleeve, wherein at least one slot on an outer wall of the insert sleeve interacts with an inner wall of the bored sleeve;
placing a tubular body around at least part of the bored sleeve and at least part of an outer strand of the transmission conductor; and
compressing the outer tubular body to the at least part of the insert sleeve and the at least part of the outer strand.
